(19) United States
(12) Patent Application Publication
(10) Pub. No.: US 2026/0351178 A1
(43) Pub. Date: Nov. 5, 2026

(54) DISPLAY DEVICE AND ELECTRONIC DEVICE INCLUDING THE SAME

(71) Applicant: Samsung Display Co., LTD., Yongin-si (KR)

(72) Inventors: KYUNG-BAE KIM, Yongin-si (KR); JINSEON KWAK, Yongin-si (KR); DONGWOO KIM, Yongin-si (KR); YONGHEE LEE, Yongin-si (KR)

(21) Appl. No.: 19/655,324

(22) Filed: Apr. 22, 2026

(30) Foreign Application Priority Data
Apr. 30, 2025 (KR) 10-2025-0057554

(51) Int. Cl. G09G 3/3233; G09G 3/32

(52) U.S. Cl. CPC G09G 3/3233; G09G 3/32; G09G 2300/0819; G09G 2300/0852; G09G 2310/08; G09G 2320/0233

(57) ABSTRACT

A display device includes a display panel including pixel rows, each including pixels, a data driver which provides a data signal to each of the pixels, a gate driver which sequentially provides pulses of write gate signals to the pixel rows, respectively, in a data writing period of a frame period, in which a data voltage is applied to each of the pixels, and an emission driver which sequentially provides pulses of emission signals to the pixel rows, respectively, in an emission period of the frame period, in which the pixels emit light. The emission period of the frame period starts after the data writing period of the frame period ends.

This application claims priority to Korean Patent Application No. 10-2025-0057554, filed on Apr. 30, 2025, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a display device including a plurality of pixels and an electronic device including the display device.

### 2. Description of the Related Art

A display device may include a display panel including pixels, a data driver that provides data signals to the pixels, a gate driver that provides gate signals to the pixels, and an emission driver that provides emission signals to the pixels. Each of the pixels may include a plurality of transistors including a driving transistor that generates a driving current, and a light-emitting element that emits light with a luminance corresponding to the driving current.

### SUMMARY

In a display device, when a voltage of a gate of a driving transistor changes while a light-emitting element emits light with a luminance corresponding to a driving current, the driving current generated by the driving transistor may change, and accordingly, the luminance of light emitted from the light-emitting element may change. When the luminance of light emitted from the pixel in one frame is not constant, an image quality of the display device may deteriorate.

Embodiments provide a display device with an improved image quality and an electronic device including the display device.

A display device according to embodiments includes a display panel including pixel rows, each including pixels, a data driver which provides a data signal to each of the pixels, a gate driver which sequentially provides pulses of write gate signals to the pixel rows, respectively, in a data writing period of a frame period, in which a data voltage is applied to each of the pixels, and an emission driver which sequentially provides pulses of emission signals to the pixel rows, respectively, in an emission period of the frame period, in which the pixels emit light. In such embodiments, the emission period of the frame period starts after the data writing period of the frame period ends.

In an embodiment, the data signal may have the data voltage in the data writing period, and may have a reference voltage in the emission period.

In an embodiment, each of the pixels may include a first transistor including a gate connected to a first node, a first terminal connected to a second node, and a second terminal, a second transistor which transmits the data signal to the first node in response to a write gate signal among the write gate signals, a third transistor which transmits a first power voltage to the second node in response to an emission signal among the emission signals, a light-emitting element including a first terminal connected to a third node and a second terminal which receives a second power voltage, a fourth transistor which transmits an initialization voltage to the third node in response to a bypass gate signal, a fifth transistor which connects the second terminal of the first transistor to the third node in response to a compensation gate signal, a first capacitor connected between the first node and the second node, and a second capacitor connected between the second node and a power line which transmits the first power voltage.

In an embodiment, the write gate signal may have a first low voltage level in a first period, may have a high voltage level higher than the first low voltage level in a second period following the first period, may have the first low voltage level in a third period following the second period, and may have the high voltage level in a fourth period following the third period.

In an embodiment, the emission signal may have the first low voltage level in the first period, may have the high voltage level in the second period and the third period, and may have the first low voltage level in the fourth period.

In an embodiment, the bypass gate signal may have the high voltage level in the first period and the second period, and may have the first low voltage level in the fourth period.

In an embodiment, the compensation gate signal may have the high voltage level in the first period, may have a second low voltage level lower than the first voltage level in the second period, and may have the first low voltage level in the fourth period.

In an embodiment, the first transistor may operate in a saturation region in the second period.

In an embodiment, the first transistor may operate in a linear region in the fourth period.

A display device according to embodiments includes a display panel including first to n^{th} pixel rows, each including pixels, where n is a natural number greater than or equal to 2, a data driver which provides a data signal to each of the pixels, a gate driver which sequentially provides pulses of first to n^{th} write gate signals to the first to n^{th} pixel rows, respectively, in a frame period, and an emission driver which sequentially provides pulses of first to n^{th} emission signals to the first to n^{th} pixel rows, respectively, in the frame period. In such embodiments, a pulse of the first emission signal in the frame period starts after a pulse of the n^{th} write gate signal in the frame period ends.

In an embodiment, an interval between a pulse of the first write gate signal and the pulse of the first emission signal may be greater than or equal to n×wt, where wt denotes a width of the pulse of the first write gate signal.

In an embodiment, each of the pixels may include a first transistor including a gate connected to a first node, a first terminal connected to a second node, and a second terminal, a second transistor which transmits the data signal to the first node in response to a write gate signal among the first to n^{th} write gate signals, a third transistor which transmits a first power voltage to the second node in response to an emission signal among the first to n^{th} emission signals, a light-emitting element including a first terminal connected to a third node and a second terminal that receives a second power voltage, a fourth transistor which transmits an initialization voltage to the third node in response to a bypass gate signal, a fifth transistor which connects the second terminal of the first transistor to the third node in response to a compensation gate signal, a first capacitor connected between the first node and the second node, and a second capacitor connected between the second node and a power line which transmits the first power voltage.

In an embodiment, the write gate signal may have a first low voltage level in a first period, may have a high voltage level higher than the first low voltage level in a second period following the first period, may have the first low voltage level in a third period following the second period, and may have the high voltage level in a fourth period following the third period.

In an embodiment, the emission signal may have the first low voltage level in the first period, may have the high voltage level in the second period and the third period, and may have the first low voltage level in the fourth period.

In an embodiment, the bypass gate signal may have the high voltage level in the first period and the second period, and may have the first low voltage level in the fourth period.

In an embodiment, the compensation gate signal may have the high voltage level in the first period, may have a second low voltage level lower than the first voltage level in the second period, and may have the first low voltage level in the fourth period.

In an embodiment, the first transistor may operate in a saturation region in the second period.

In an embodiment, the first transistor may operate in a linear region in the fourth period.

An electronic device according to embodiments includes a processor which generates input image data, and a display device which displays an image corresponding to the input image data. In such embodiments, the display device includes a display panel including pixel rows, each including pixels, a data driver which provides a data signal to each of the pixels, a gate driver which sequentially provides pulses of write gate signals to the pixel rows, respectively, in a data writing period of a frame period, in which a data voltage is applied to each of the pixels, and an emission driver which sequentially provides pulses of emission signals to the pixel rows, respectively, in an emission period of the frame period, in which the pixels emit light. In such embodiments, the emission period of the frame period starts after the data writing period of the frame period ends.

In an embodiment, the data signal may have the data voltage in the data writing period, and may have a reference voltage in the emission period.

In the display device and the electronic device according to embodiments, the data writing period in which the pulses of the write gate signals are sequentially provided and the emission period in which the pulses of the emission signals are sequentially provided are separated, so that a change in data voltage in the data writing period may not affect driving currents of the pixels in the emission period. Accordingly, the pixels may emit light with a constant luminance in the emission period, and the image quality of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a signal timing diagram illustrating an embodiment of write gate signals, emission signals, and a data signal of FIG. 1.

FIG. 3 is a circuit diagram illustrating an embodiment of a pixel of FIG. 1.

FIG. 4 is a signal timing diagram illustrating an embodiment of signals of FIG. 3.

FIG. 5 is a diagram for describing an operation of the pixel of FIG. 3 in a first period of FIG. 4.

FIG. 6 is a diagram for describing an operation of the pixel of FIG. 3 in a second period of FIG. 4.

FIG. 7 is a diagram for describing an operation of the pixel of FIG. 3 in a third period of FIG. 4.

FIG. 8 is a diagram for describing an operation of the pixel of FIG. 3 in a fourth period of FIG. 4.

FIG. 9 is a block diagram illustrating an electronic device according to an embodiment.

FIG. 10 is a diagram illustrating electronic devices according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a display device and an electronic device according to embodiments of the present disclosure will be described in detail with reference to the accompanying drawings. The same or similar reference numerals will be used for the same elements in the accompanying drawings.

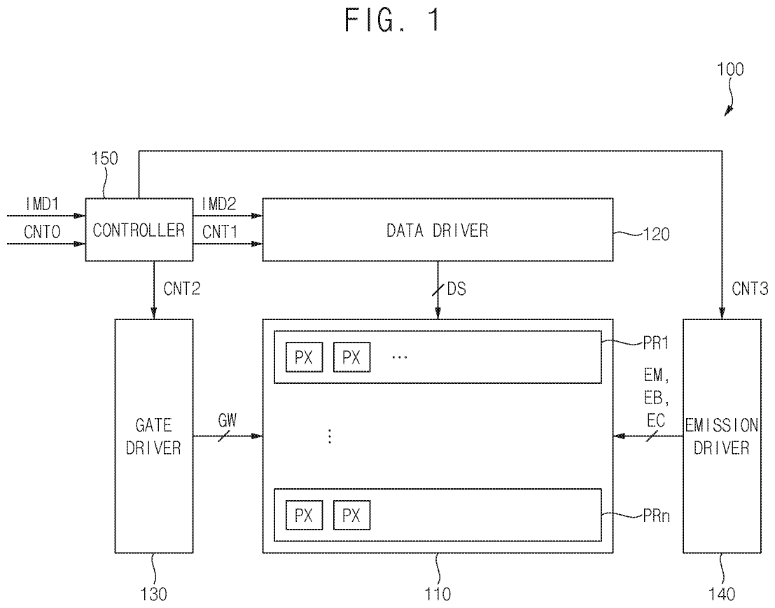

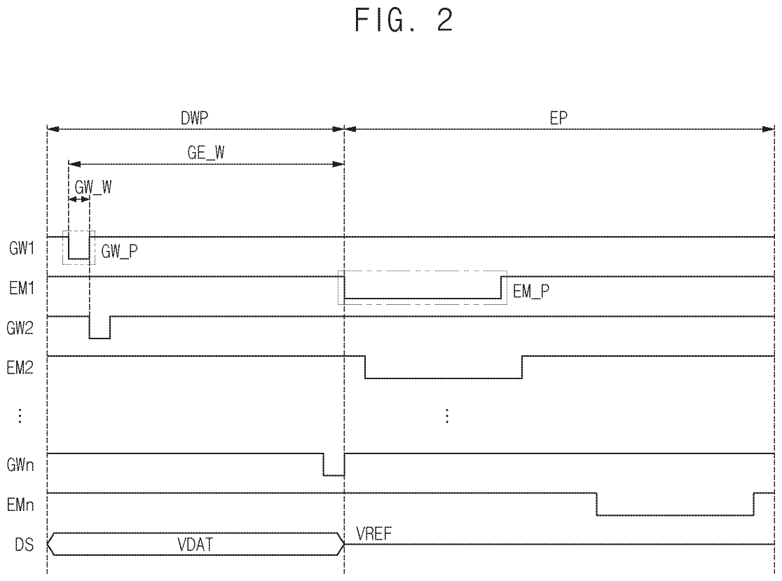

FIG. 1 is a block diagram illustrating a display device 100 according to an embodiment. FIG. 2 is a signal timing diagram illustrating an embodiment of write gate signals GW, emission signals EM, and a data signal DS of FIG. 1.

Referring to FIGS. 1 and 2, an embodiment of a display device 100 may include a display panel 110, a data driver 120, a gate driver 130, an emission driver 140, and a controller 150.

The display panel 110 may include a plurality of pixel rows. In an embodiment, the display panel 110 may include first to n^{th} pixel rows PR1, . . . , PRn, where n is a natural number greater than or equal to 2. Each of the first to n^{th} pixel rows PR1, . . . , PRn may include a plurality of pixels PX.

The data driver 120 may provide a data signal DS to each of the pixels PX. The data driver 120 may generate the data signal DS based on output image data IMD2 and a first control signal CNT1. The data signal DS may have a data voltage VDAT in a data writing period DWP, and may have a reference voltage VREF in an emission period EP. The data voltage VDAT may be applied to each of the pixels PX in the data writing period DWP. The pixels PX may emit light in the emission period EP. The data driver 120 may convert the digital output image data IMD2 into the analog data voltage VDAT. The first control signal CNT1 may include a load signal, a data clock signal, an output data enable signal, etc.

The gate driver 130 may provide write gate signals GW to the pixel rows, respectively. In an embodiment, the gate driver 130 may provide first to n^{th} write gate signals GW1, GW2, . . . , GWn to the first to n^{th} pixel rows PR1, . . . , PRn, respectively. The gate driver 130 may sequentially provide pulses of the write gate signals GW to the pixel rows, respectively, in the data writing period DWP. In an embodiment, the gate driver 130 may sequentially provide pulses GW_P of the first to n^{th} write gate signals GW1, GW2, . . . , GWn to the first to n^{th} pixel rows PR1, . . . , PRn, respectively, in the data writing period DWP. A width GW_W of the pulse GW_P of each of the first to n^{th} write gate signals GW1, GW2, . . . , GWn may be equal to one horizontal time length (or a horizontal period). The second write gate signal GW2 may be a signal in which the first write gate signal GW1 is shifted by one horizontal time length. The gate driver 130 may generate the write gate signals GW based on a second control signal CNT2. The second control signal CNT2 may include a write gate start signal, a write gate clock signal, etc.

The emission driver 140 may provide emission signals EM to the pixel rows, respectively. In an embodiment, the emission driver 140 may provide first to n^{th} emission signals EM1, EM2, . . . , EMn to the first to n^{th} pixel rows PR1, . . . , PRn, respectively. The emission driver 140 may sequentially provide pulses of the emission signals EM to the pixel rows, respectively, in the emission period EP. In an embodiment, the emission driver 140 may sequentially provide pulses EM_P of the first to n^{th} emission signals EM1, EM2, . . . , EMn to the first to n^{th} pixel rows PR1, . . . , PRn, respectively, in the emission period EP. The second emission signal EM2 may be a signal in which the first emission signal EM1 is shifted by one horizontal time length. The emission driver 140 may generate the emission signals EM based on a third control signal CNT3. The third control signal CNT3 may include an emission start signal, an emission clock signal, etc.

In an embodiment, the emission period EP may start after the data writing period DWP ends. A pulse EM_P of the first emission signal EM1 may start after a pulse GW_P of the n^{th} write gate signal GWn ends. FIG. 2 illustrates an embodiment in which the pulse EM_P of the first emission signal EM1 starts immediately after the pulse GW_P of the n^{th} write gate signal GWn ends, but the present disclosure is not limited thereto. In another embodiment, the pulse EM_P of the first emission signal EM1 may start a predetermined length of time after the pulse GW_P of the n^{th} write gate signal GWn ends.

In one pixel row, an interval GE_W between the pulse GW_P of the write gate signal GW and the pulse EM_P of the emission signal EM may be greater than or equal to a value obtained by multiplying one horizontal time length by the number n of pixel rows included in the display panel 110. An interval GE_W between the pulse GW_P of the first write gate signal GW1 and the pulse EM_P of the first emission signal EM1 may be greater than or equal to n×wt, where wt denotes a width GW_W of the pulse GW_P of the first write gate signal GW1. FIG. 2 illustrates an embodiment in which the interval GE_W between the pulse GW_P of the first write gate signal GW1 and the pulse EM_P of the first emission signal EM1 is n×wt, but the present disclosure is not limited thereto.

The emission driver 140 may provide bypass gate signals EB to the pixel rows, respectively. The emission driver 140 may generate the bypass gate signals EB based on the third control signal CNT3. The third control signal CNT3 may further include a bypass gate start signal and a bypass gate clock signal.

The emission driver 140 may provide compensation gate signals EC to pixel rows, respectively. The emission driver 140 may generate the compensation gate signals EC based on the third control signal CNT3. The third control signal CNT3 may further include a compensation gate start signal and a compensation gate clock signal.

FIG. 1 illustrates an embodiment in which the emission driver 140 provides the bypass gate signals EB and the compensation gate signals EC, but the present disclosure is not limited thereto. In an embodiment, the gate driver 130 may provide at least one selected from the bypass gate signals EB and the compensation gate signals EC.

The controller 150 may control the data driver 120, the gate driver 130, and the emission driver 140. The controller 150 may provide the output image data IMD2 and the first control signal CNT1 to the data driver 120, may provide the second control signal CNT2 to the gate driver 130, and may provide the third control signal CNT3 to the emission driver 140. The controller 150 may generate the output image data IMD2, the first control signal CNT1, the second control signal CNT2, and the third control signal CNT3 based on input image data IMD1 and an input control signal CNT0. In an embodiment, the input image data IMD1 may include red image data, green image data, and blue image data. The input control signal CNT0 may include a vertical synchronization signal, a horizontal synchronization signal, a master clock signal, an input data enable signal, etc.

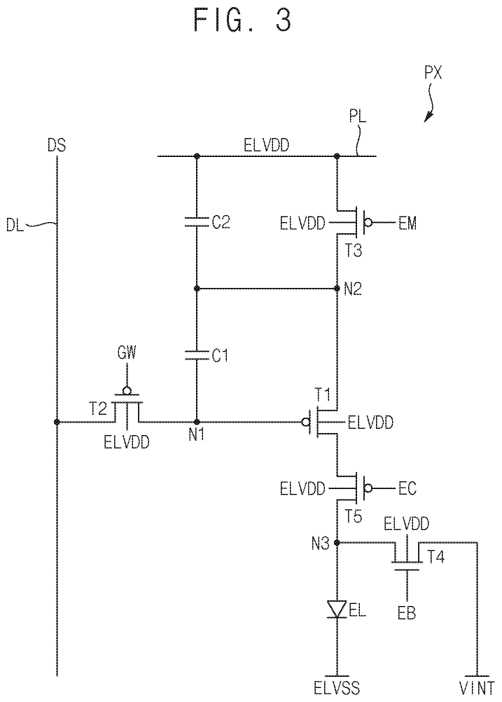

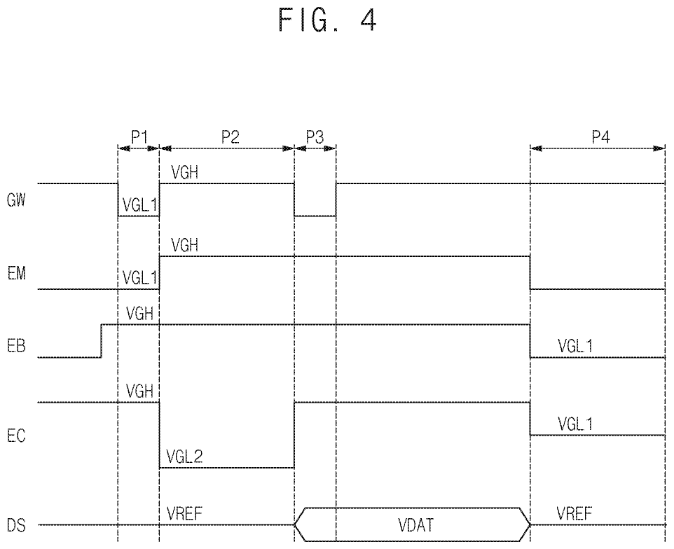

FIG. 3 is a circuit diagram illustrating an embodiment of the pixel PX of FIG. 1. FIG. 4 is a signal timing diagram illustrating an embodiment of the signals GW, EM, EB, EC, and DS of FIG. 3.

Referring to FIGS. 3 and 4, in an embodiment, the pixel PX may receive a write gate signal GW, an emission signal EM, a bypass gate signal EB, a compensation gate signal EC, a data signal DS, a first power voltage ELVDD, a second power voltage ELVSS, and an initialization voltage VINT. A voltage level of the first power voltage ELVDD may be higher than a voltage level of the second power voltage ELVSS. In an embodiment, as shown in FIG. 3, the pixel PX may include a first transistor T1, a second transistor T2, a third transistor T3, a light-emitting element EL, a fourth transistor T4, a fifth transistor T5, a first capacitor C1, and a second capacitor C2.

The first transistor T1 may include a gate connected to a first node N1, a first terminal connected to a second node N2, and a second terminal. The first transistor T1 may be referred to as a driving transistor.

The second transistor T2 may transmit the data signal DS to the first node N1 in response to the write gate signal GW. The second transistor T2 may include a gate that receives the write gate signal GW, a first terminal connected to a data line DL that transmits the data signal DS, and a second terminal connected to the first node N1.

The third transistor T3 may transmit the first power voltage ELVDD to the second node N2 in response to the emission signal EM. The third transistor T3 may include a gate that receives the emission signal EM, a first terminal connected to a power line PL that transmits the first power voltage ELVDD, and a second terminal connected to the second node N2.

The light-emitting element EL may include a first terminal (e.g., an anode) connected to a third node N3 and a second terminal (e.g., a cathode) that receives the second power voltage ELVSS. In an embodiment, the light-emitting element EL may be one of an organic light-emitting diode, an inorganic light-emitting diode, a quantum dot light-emitting diode, and a micro light-emitting diode.

The fourth transistor T4 may transmit the initialization voltage VINT to the third node N3 in response to the bypass gate signal EB. The fourth transistor T4 may include a gate that receives the bypass gate signal EB, a first terminal that receives the initialization voltage VINT, and a second terminal connected to the third node N3.

The fifth transistor T5 may connect the second terminal of the first transistor T1 to the third node N3 in response to the compensation gate signal EC. The fifth transistor T5 may include a gate that receives the compensation gate signal EC, a first terminal connected to the second terminal of the first transistor T1, and a second terminal connected to the third node N3.

In an embodiment, as illustrated in FIG. 3, each of the first transistor T1, the second transistor T2, the third transistor T3, and the fifth transistor T5 may be a p-type transistor (e.g., a p-channel metal-oxide-semiconductor (PMOS) transistor), and the fourth transistor T4 may be an n-type transistor (e.g., an n-channel metal-oxide-semiconductor (NMOS) transistor). In an embodiment, at least one selected from the first transistor T1, the second transistor T2, the third transistor T3, and the fifth transistor T5 may be an n-type transistor, or the fourth transistor T4 may be a p-type transistor.

In an embodiment, as illustrated in FIG. 3, each of the first transistor T1, the second transistor T2, the third transistor T3, the fourth transistor T4, and the fifth transistor T5 may further include a body that receives the first power voltage ELVDD.

The first capacitor C1 may be connected between the first node N1 and the second node N2. The first capacitor C1 may include a first terminal connected to the first node N1 and a second terminal connected to the second node N2.

The second capacitor C2 may be connected between the second node N2 and the power line PL. The second capacitor C2 may include a first terminal connected to the second node N2 and a second terminal connected to the power line PL.

In an embodiment, as shown in FIG. 4, a frame period of the pixel PX may include a first period P1, a second period P2 following the first period P1, a third period P3 following the second period P2, and a fourth period P4 following the third period P3.

The write gate signal GW may have a first low voltage level VGL1 in the first period P1, may have a high voltage level VGH in the second period P2, may have the first low voltage level VGL1 in the third period P3, and may have the high voltage level VGH in the fourth period P4. The high voltage level VGH may be higher than the first low voltage level VGL1. The first low voltage level VGL1 may be a turn-on voltage level of a p-type transistor and a turn-off voltage level of an n-type transistor. The high voltage level VGH may be the turn-off voltage level of the p-type transistor and the turn-on voltage level of the n-type transistor.

The emission signal EM may have the first low voltage level VGL1 in the first period P1, may have the high voltage level VGH in the second period P2 and the third period P3, and may have the first low voltage level VGL1 in the fourth period P4.

The bypass gate signal EB may have the high voltage level VGH in the first period P1 and the second period P2, and may have the first low voltage level VGL1 in the fourth period P4. In an embodiment, the bypass gate signal EB may have the high voltage level VGH in the third period P3, as illustrated in FIG. 4. In an embodiment, the bypass gate signal EB may have the first low voltage level VGL1 in the third period P3.

The compensation gate signal EC may have the high voltage level VGH in the first period P1, may have a second low voltage level VGL2 in the second period P2, and may have the first low voltage level VGL1 in the fourth period P4. The second low voltage level VGL2 may be lower than the first low voltage level VGL1. The second low voltage level VGL2 may be a turn-on voltage level of the p-type transistor. In an embodiment, the compensation gate signal EC may have the high voltage level VGH in the third period P3, as illustrated in FIG. 4. In an embodiment, the compensation gate signal EC may have the second low voltage level VGL2 in the third period P3.

The data signal DS may have the reference voltage VREF in the first period P1, the second period P2, and the fourth period P4, and may have the data voltage VDAT in the third period P3.

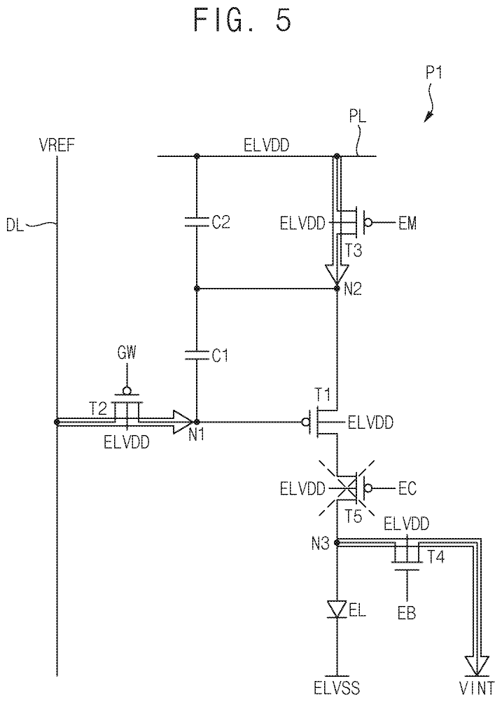

FIG. 5 is a diagram for describing an operation of the pixel of FIG. 3 in the first period P1 of FIG. 4.

Referring to FIGS. 4 and 5, in the first period P1, each of the write gate signal GW and the emission signal EM may have the first low voltage level VGL1, each of the compensation gate signal EC and the bypass gate signal EB may have the high voltage level VGH, and the data signal DS may have the reference voltage VREF. In the first period P1, the reference voltage VREF may be applied to the first node N1 through the second transistor T2 that is turned on (or in a turn-on state) in response to the first low voltage level VGL1 of the write gate signal GW. In the first period P1, the first power voltage ELVDD may be applied to the second node N2 through the third transistor T3 that is turned on in response to the first low voltage level VGL1 of the emission signal EM. In the first period P1, the initialization voltage VINT may be applied to the third node N3 through the fourth transistor T4 that is turned on in response to the high voltage level VGH of the bypass gate signal EB. Accordingly, the first transistor T1, the first capacitor C1, and the light-emitting element EL may be initialized in the first period P1.

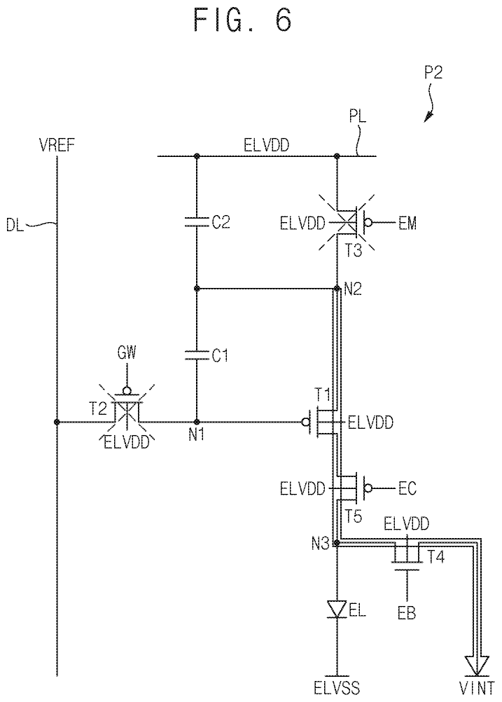

FIG. 6 is a diagram for describing an operation of the pixel of FIG. 3 in the second period P2 of FIG. 4.

Referring to FIGS. 4 and 6, in the second period P2, each of the write gate signal GW, the emission signal EM, and the bypass gate signal EB may have the high voltage level VGH, the compensation gate signal EC may have the second low voltage level VGL2, and the data signal DS may have the reference voltage VREF. In the second period P2, a current may flow from the second node N2 to a line that transmits the initialization voltage VINT through the turned-on first transistor T1, the fifth transistor T5 that is turned on in response to the second low voltage level VGL2 of the compensation gate signal EC, and the fourth transistor T4 that is turned on in response to the high voltage level VGH of the bypass gate signal EB until a voltage difference between the gate and the first terminal of the first transistor T1 becomes equal to a threshold voltage of the first transistor T1. Accordingly, the threshold voltage of the first transistor T1 may be stored in the first capacitor C1 in the second period P2.

In the second period P2, the first transistor T1 may operate in a saturation region. In the second period P2, since the second low voltage level VGL2 of the compensation gate signal EC is applied to the gate of the fifth transistor T5, a voltage level of the second terminal of the first transistor T1 (the first terminal of the fifth transistor T5) may be lower than a voltage level of the first terminal of the first transistor T1, and a condition for the first transistor T1 to operate in the saturation region may satisfy the following mathematical formula 1.

Vsd>Vsg−|Vth| [Mathematical Formula 1]

In mathematical formula 1, Vsd denotes a voltage difference between the first terminal and the second terminal of the first transistor T1, Vsg denotes the voltage difference between the first terminal and the gate of the first transistor T1, and Vth denotes the threshold voltage of the first transistor T1.

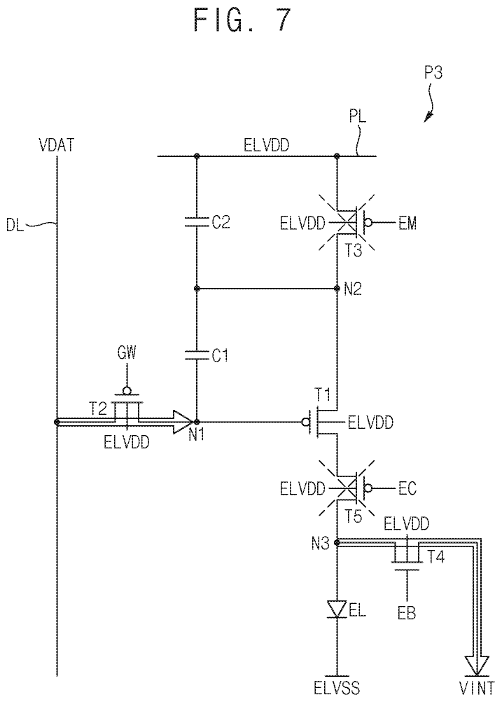

FIG. 7 is a diagram for describing an operation of the pixel of FIG. 3 in the third period P3 of FIG. 4.

Referring to FIGS. 4 and 7, in the third period P3, the write gate signal GW may have the first low voltage level VGL1, each of the emission signal EM, the bypass gate signal EB, and the compensation gate signal EC may have the high voltage level VGH, and the data signal DS may have the data voltage VDAT. In the third period P3, the data voltage VDAT may be applied to the first node N1 through the second transistor T2 that is turned on in response to the first low voltage level VGL1 of the write gate signal GW. In the third period P3, the initialization voltage VINT may be applied to the third node N3 through the fourth transistor T4 that is turned on in response to the high voltage level VGH of the bypass gate signal EB. Accordingly, the data voltage VDAT may be written to the gate of the first transistor T1 in the third period P3.

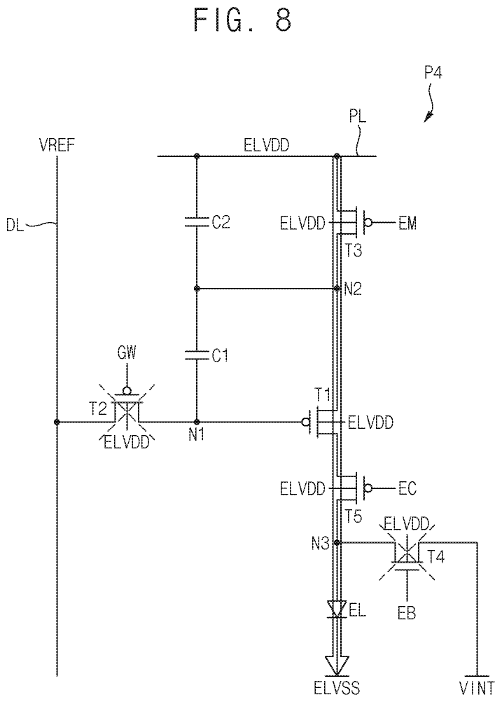

FIG. 8 is a diagram for describing an operation of the pixel of FIG. 3 in the fourth period P4 of FIG. 4.

Referring to FIGS. 4 and 8, in the fourth period P4, the write gate signal GW may have the high voltage level VGH, each of the emission signal EM, the bypass gate signal EB, and the compensation gate signal EC may have the first low voltage level VGL1, and the data signal DS may have the reference voltage VREF. In the fourth period P4, a current path for a driving current may be formed from the power line PL to a line that transmits the second power voltage ELVSS through the third transistor T3 that is turned on in response to the first low voltage level VGL1 of the emission signal EM, the first transistor T1 in a turn-on state, the fifth transistor T5 that is turned on in response to the first low voltage level VGL1 of the compensation gate signal EC, and the light-emitting element EL, the first transistor T1 may generate the driving current based on a voltage difference between the first node N1 and the second node N2 stored in the first capacitor C1, and the light-emitting element EL may emit light with a luminance corresponding to the driving current. Accordingly, the light-emitting element EL may emit light with a luminance corresponding to the data voltage VDAT for which the threshold voltage of the first transistor T1 is compensated in the fourth period P4.

In the fourth period P4, the first transistor T1 may operate in a linear region. In the fourth period P4, since the fifth transistor T5 functions as an active load, a voltage level of the second terminal of the first transistor T1 may be stabilized (the voltage level of the second terminal of the first transistor T1 may remain unchanged), and accordingly, a voltage level of the gate of the first transistor T1 may be stabilized (the voltage level of the gate of the first transistor T1 may remain unchanged). Accordingly, in the fourth period P4, the voltage difference between the first terminal and the gate of the first transistor T1 may maintain or be constant, and the light-emitting element EL may emit light with a constant luminance.

In a comparative example of the prior art (or in a conventional display device), the emission period EP in which the pulses EM_P of the emission signals EM1, EM2, . . . , EMn are sequentially provided may partially overlap the data writing period DWP in which the pulses GW_P of the write gate signals GW1, GW2, . . . , GWn are sequentially provided. In this case, in the pixel PX, while the light-emitting element EL emits light based on the voltage difference between the first node N1 and the second node N2 stored in the first capacitor C1 (i.e., during the fourth period P4), a change in the data voltage VDAT transmitted by the data line DL due to a coupling between the data line DL and the first node N1 may affect a voltage of the first node N1, and a luminance of light emitted by the light-emitting element EL may change as the driving current flowing in the light-emitting element EL changes. Accordingly, an image quality of the display device may deteriorate.

In an embodiment of the present disclosure, the emission period EP may not overlap the data writing period DWP, and a change in the data voltage VDAT in the data writing period DWP may not affect the driving currents of the pixels PX in the emission period EP. Accordingly, the pixels PX may emit light with a constant luminance in the emission period EP, and the image quality of the display device 100 may be improved.

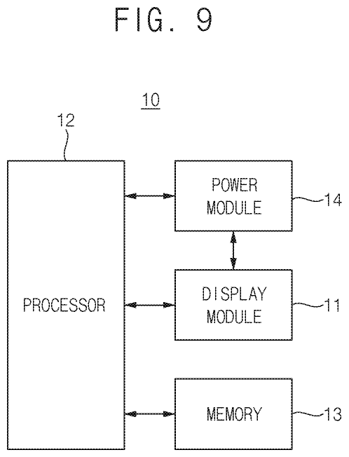

FIG. 9 is a block diagram illustrating an electronic device 10 according to an embodiment.

Referring to FIG. 9, an embodiment of an electronic device 10 may include a display module 11, a processor 12, a memory 13, and a power module 14.

The processor 12 may include at least one selected from a central processing unit (CPU), an application processor (AP), a graphic processing unit (GPU), a communication processor (CP), an image signal processor (ISP), and a controller.

The memory 13 may store data information used for an operation of the processor 12 or the display module 11. When the processor 12 executes an application stored in the memory 13, the input image data IMD1 of FIG. 1 and the input control signal CNT0 of FIG. 1 may be transmitted to the display module 11, and the display module 11 may output image information based on the input image data IMD1 and the input control signal CNT0.

The power module 14 may include a power supply module such as a power adapter, a battery device, etc. and a power conversion module that converts power supplied by the power supply module to generate power used for an operation of the electronic device 10.

At least one of the components of the electronic device 10 described above may be included in the display device 100 of FIG. 1 according to the embodiments described above. Further, some of individual modules functionally included in one module may be included in the display device 100, and others may be provided separately from the display device 100. In an embodiment, for example, the display device 100 may include the display module 11, and the processor 12, the memory 13, and the power module 14 may be provided in the form of other devices within the electronic device 10 other than the display device 100.

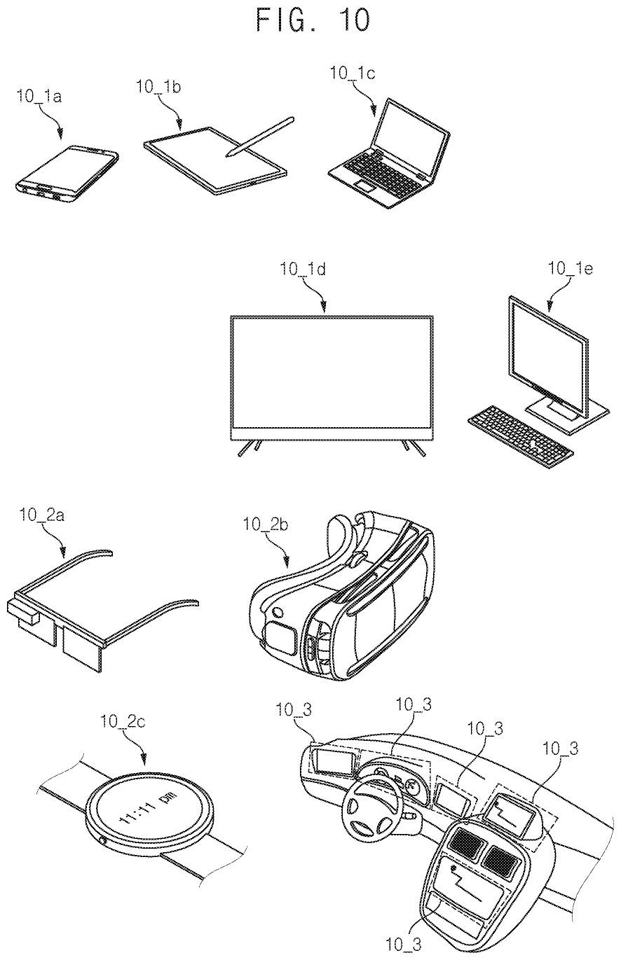

FIG. 10 is a diagram illustrating electronic devices according to embodiments.

Referring to FIG. 10, embodiments of an electronic device to which display devices according to embodiments are applied may include not only image display electronic devices such as a smart phone 10_1a, a tablet personal computer (PC) 10_1b, a laptop computer 10_1c, a television (TV) 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display CID arranged on a dashboard, a room mirror display, etc.

The display device according to embodiments may be applied to a display device included in a computer, a notebook computer, a mobile phone, a smart phone, a smart pad, a smart watch, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device, comprising:
a display panel comprising pixel rows, each comprising pixels;
a data driver which provides a data signal to each of the pixels;
a gate driver which sequentially provides pulses of write gate signals to the pixel rows, respectively, in a data writing period of a frame period, in which a data voltage is applied to each of the pixels; and
an emission driver which sequentially provides pulses of emission signals to the pixel rows, respectively, in an emission period of the frame period, in which the pixels emit light,
wherein the emission period of the frame period starts after the data writing period of the frame period ends.

2. The display device of claim 1, wherein the data signal has the data voltage in the data writing period, and has a reference voltage in the emission period.

3. The display device of claim 1, wherein each of the pixels comprises:
a first transistor comprising a gate connected to a first node, a first terminal connected to a second node, and a second terminal;
a second transistor which transmits the data signal to the first node in response to a write gate signal among the write gate signals;
a third transistor which transmits a first power voltage to the second node in response to an emission signal among the emission signals;
a light-emitting element comprising a first terminal connected to a third node and a second terminal which receives a second power voltage;
a fourth transistor which transmits an initialization voltage to the third node in response to a bypass gate signal;
a fifth transistor which connects the second terminal of the first transistor to the third node in response to a compensation gate signal;
a first capacitor connected between the first node and the second node; and
a second capacitor connected between the second node and a power line which transmits the first power voltage.

4. The display device of claim 3, wherein the write gate signal has a first low voltage level in a first period, has a high voltage level higher than the first low voltage level in a second period following the first period, has the first low voltage level in a third period following the second period, and has the high voltage level in a fourth period following the third period.

5. The display device of claim 4, wherein the emission signal has the first low voltage level in the first period, has the high voltage level in the second period and the third period, and has the first low voltage level in the fourth period.

6. The display device of claim 4, wherein the bypass gate signal has the high voltage level in the first period and the second period, and has the first low voltage level in the fourth period.

7. The display device of claim 4, wherein the compensation gate signal has the high voltage level in the first period, has a second low voltage level lower than the first voltage level in the second period, and has the first low voltage level in the fourth period.

8. The display device of claim 7, wherein the first transistor operates in a saturation region in the second period.

9. The display device of claim 7, wherein the first transistor operates in a linear region in the fourth period.

10. A display device, comprising:
a display panel comprising first to n^{th} pixel rows, each comprising pixels, wherein n is a natural number greater than or equal to 2;
a data driver which provides a data signal to each of the pixels;
a gate driver which sequentially provides pulses of first to n^{th} write gate signals to the first to n^{th} pixel rows, respectively, in a frame period; and
an emission driver which sequentially provides pulses of first to n^{th} emission signals to the first to n^{th} pixel rows, respectively, in the frame period,
wherein a pulse of the first emission signal in the frame period starts after a pulse of the n^{th} write gate signal in the frame period ends.

11. The display device of claim 10, wherein an interval between a pulse of the first write gate signal and the pulse of the first emission signal is greater than or equal to n×wt, wherein wt denotes a width of the pulse of the first write gate signal.

12. The display device of claim 10, wherein each of the pixels comprises:
a first transistor comprising a gate connected to a first node, a first terminal connected to a second node, and a second terminal;
a second transistor which transmits the data signal to the first node in response to a write gate signal among the first to n^{th} write gate signals;
a third transistor which transmits a first power voltage to the second node in response to an emission signal among the first to n^{th} emission signals;
a light-emitting element comprising a first terminal connected to a third node and a second terminal which receives a second power voltage;
a fourth transistor which transmits an initialization voltage to the third node in response to a bypass gate signal;
a fifth transistor which connects the second terminal of the first transistor to the third node in response to a compensation gate signal;
a first capacitor connected between the first node and the second node; and
a second capacitor connected between the second node and a power line which transmits the first power voltage.

13. The display device of claim 12, wherein the write gate signal has a first low voltage level in a first period, has a high voltage level higher than the first low voltage level in a second period following the first period, has the first low voltage level in a third period following the second period, and has the high voltage level in a fourth period following the third period.

14. The display device of claim 13, wherein the emission signal has the first low voltage level in the first period, has the high voltage level in the second period and the third period, and has the first low voltage level in the fourth period.

15. The display device of claim 13, wherein the bypass gate signal has the high voltage level in the first period and the second period, and has the first low voltage level in the fourth period.

16. The display device of claim 13, wherein the compensation gate signal has the high voltage level in the first period, has a second low voltage level lower than the first voltage level in the second period, and has the first low voltage level in the fourth period.

17. The display device of claim 16, wherein the first transistor operates in a saturation region in the second period.

18. The display device of claim 16, wherein the first transistor operates in a linear region in the fourth period.

19. An electronic device, comprising:
a processor which generates input image data; and
a display device which displays an image corresponding to the input image data,
wherein the display device comprises:
a display panel comprising pixel rows, each comprising pixels;
a data driver which provides a data signal to each of the pixels;
a gate driver which sequentially provides pulses of write gate signals to the pixel rows, respectively, in a data writing period of a frame period, in which a data voltage is applied to each of the pixels; and
an emission driver which sequentially provides pulses of emission signals to the pixel rows, respectively, in an emission period of the frame period, in which the pixels emit light,
wherein the emission period of the frame period starts after the data writing period of the frame period ends.

20. The electronic device of claim 19, wherein the data signal has the data voltage in the data writing period, and has a reference voltage in the emission period.
